(19) United States
(12) Patent Application Publication
(10) Pub. No.: US 2023/0079384 A1
(43) Pub. Date: Mar. 16, 2023

(54) OPTICAL SENSOR AND METHOD FOR MANUFACTURING OPTICAL SENSOR

(71) Applicant: SHUNSIN TECHNOLOGY (ZHONG SHAN) LIMITED, Zhongshan (CN)

(72) Inventor: SHUN-HSING LIAO, Zhongshan City (CN)

(21) Appl. No.: 17/485,811

(22) Filed: Sep. 27, 2021

(30) Foreign Application Priority Data
Sep. 13, 2021 (CN) 202111070737.7

(51) Int. Cl. G01S 7/481; G01S 17/08; G01S 7/4865

(52) U.S. Cl. CPC G01S 7/4814; G01S 17/08; G01S 7/4865

(57) ABSTRACT

A high-precision optical sensor employed in time-of-flight distance detection avoids undesired light affecting the integrity of distance measurement and includes a substrate, a cover, a light emitter, and measurement and reference photodetectors. The substrate includes a surface and grooves. When in place, the cover forms an internal space. The cover has protrusions, a first light transmitting portion, and a second light transmitting portion. The protrusions extend toward the substrate and divide the internal space into interconnected first chamber and second chamber. The light emitter is arranged on the substrate and located in the first chamber, the measurement photodetector is disposed on the groove and located in the second chamber and the reference photodetector enables precise timing by being shielded against internal and unwanted stray light.

### FIELD

The subject matter herein generally relates to optical transmissions and sensors.

### BACKGROUND

A time-of-flight (ToF) measurement measures the distance between a sensor and an object by the time difference between the emission of a light and the return of its reflection from an object.

However, optical sensors that use time-of-flight distance measurement suffer internal light leakage, which affects the accuracy of distance measurement. Therefore, there is room for improvement within the art.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic cross-sectional diagram of an optical sensor according to an embodiment of the disclosure;

FIG. 2 is a schematic cross-sectional diagram of the substrate of the optical sensor according to an embodiment of the disclosure; and

FIGS. 3A, 3B, 3C, 3D, 3E and 3F are schematic cross-sectional diagrams illustrating a process flow of a method of manufacturing an optical sensor according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

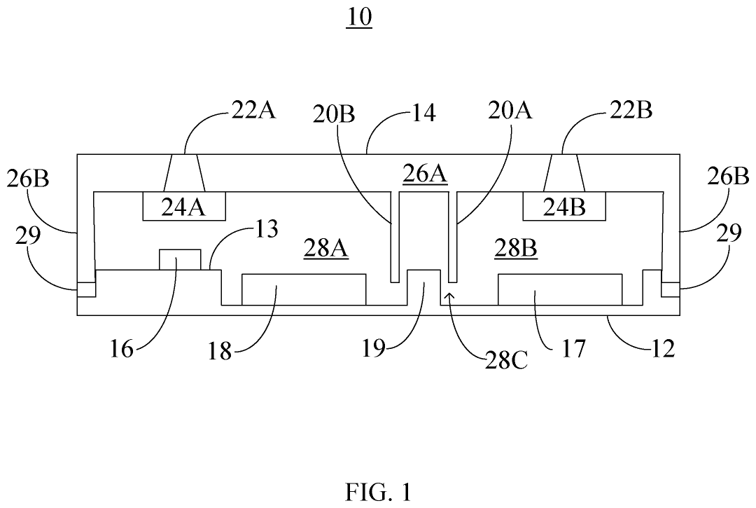

FIG. 1 illustrates an optical sensor according to an embodiment of the disclosure. As shown in FIG. 1, the optical sensor 10 comprises a substrate 12, a cover 14, a light emitter 16, a measurement photodetector 17, and a reference photodetector 18.

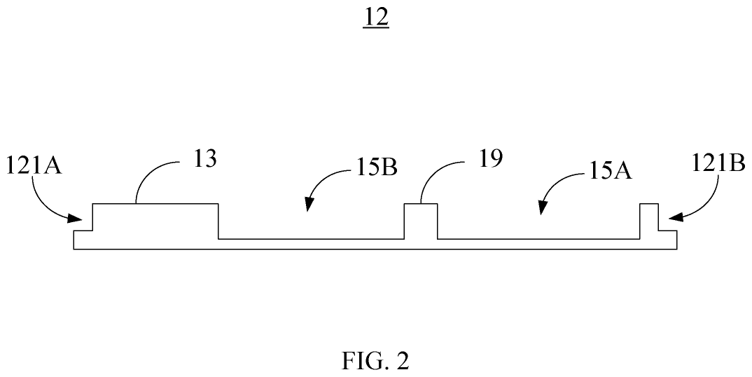

FIG. 2 illustrates the substrate 12 according to an embodiment of the disclosure. As shown in FIG. 1 and FIG. 2, the substrate 12 has a surface 13, a first groove 15A, and a second groove 15B. There is a partition wall 19 between the first groove 15A and the second groove 15B. According to an embodiment of the disclosure, the partition wall 19 is a part of the substrate 12, and the top of the partition wall 19 is coplanar with the surface 13 of the substrate 12. In addition, there are accommodating grooves 121A and 121B on both sides of the substrate 12 for accommodating the cover 14.

The substrate 12 can be made of different materials, such as plastic materials, epoxy materials, composite materials, FR-4 materials, or ceramic materials. The substrate 12 has an connective structure which has bonding pads to couple with related electronic components. The related electronic components may include circuit components and control circuits necessary for implementing the functions of transmitting or receiving light signals. The related electronic components are well known to those skilled in the art, and will not be repeated here.

The cover 14 is connected to the substrate 12 and forms an internal space with the substrate 12. According to an embodiment, the material of the cover 14 may be an opaque plastic polymer material. The cover 14 comprises a top cover 26A and side walls 26B extending from the periphery of the top cover 26A toward the substrate 12 and connected to the accommodating grooves 121A and 121B of the substrate 12. The cover 14 further comprises protrusions 20A and 20B, a first light transmitting portion 22A, and a second light transmitting portion 22B. The protrusions 20A and 20B are located on the surface of the top cover 26A facing the substrate 12 and extending toward the substrate 12, the respective bottoms of the protrusions 20A and 20B straddle the partition wall 19 and extend partly into the first groove 15A and the second groove 15B.

According to the embodiment, the protrusions 20A and 20B may be independent elements or can be integrally formed with the top cover 26A. The protrusion 20A divides the internal space formed by the cover 14 and the substrate 12 into a first chamber 28A and a second chamber 28B that communicate with each other. As shown in FIG. 1, there is a communication chamber 28C between the first chamber 28A and the second chamber 28B, and between the bottom of the protrusions 20A and the first groove 15A.

The light emitter 16 is disposed on the surface 13 of the substrate 12 and is located in the first chamber 28A. In the embodiment of the disclosure, the light emitter 16 can be one or multiple vertical cavity surface emitting laser diodes (hereinafter referred to as VCSELs). The VCSELs form an array to emit light signals. In other embodiments, the light emitter 16 can be light emitting diodes, edge emitting laser diodes (EELD), or distributed feedback lasers (DFB). In an embodiment of the disclosure, the light emitter 16 emits light beams in the infrared waveband. In other embodiments, the light emitter 16 can also emit light in other wavebands such as visible light and ultraviolet light.

According to an embodiment of the disclosure, the optical sensor 10 further comprises a measurement photodetector 17 and a reference photodetector 18. The measurement photodetector 17 is disposed on the bottom of the first groove 15A and is located in the second chamber 28B. The reference photodetector 18 is disposed on the bottom of the second groove 15B and is located in the first chamber 28A. The photodetector types constituting the measurement photodetector 17 and reference photodetector 18 may include PN-type photodiodes, PIN-type photodiodes, and avalanche-type photodiodes. According to an embodiment of the disclosure, the heights of the measurement photodetector 17 and the reference photodetector 18 may be less than the heights of the sidewalls of the first groove 15A and the second groove 15B, so that the top positions of the measurement photodetector 17 and the reference photodetector 18 are lower than the surface 13 of the substrate 12.

In addition, the first light filter 24A and the second light filter 24B are respectively provided in the first light transmitting portion 22A and the second light transmitting portion 22B. The position of the first light transmitting part 22A corresponds to the light emitter 16, and that of the second light transmitting part 22B corresponds to the measurement photodetector 17. The light emitter 16 emits a light beam according to the control signal issued by the control circuit (not shown in the figures). The emitted light beam passes through the first light filter 24A of the first light transmitting portion 22A towards a target, and the reflected light returns to the measurement photodetector 17 through the second light filter 24B of the second light transmitting portion 22B.

The first optical filter 24A and the second optical filter 24B are designed to filter out light which is outside the frequency band emitted by the optical transmitter 16, so that the measurement photodetector 17 can analyze only the pure reflected light more accurately. According to another embodiment, a lens may be used instead of the optical filter to control the direction of the emitted light beam, or a lens combined with the optical filter may be used to achieve better optical path and light transmission quality.

The partition wall 19 is located between the first groove 15A and the second groove 15B, and between the protrusions 20A and 20B. Since the top of the partition wall 19 is coplanar with the surface 13 of the substrate 12, the bottom of the protrusion 20A facing the substrate 12 is below the top of the partition wall 19 and the bottom of the protrusion 20B facing the substrate 12 is also below the top of the partition wall 19.

As shown in FIG. 1, there is a first distance between the bottom of the protrusion 20A and the first groove 15A, a second distance between the bottom of the protrusion 20B and the second groove 15B, a third distance between the top of the partition wall 19 and the top cover 26A, a fourth distance between the partition wall 19 and the protrusion 20A along the direction parallel to the surface of the substrate 12, and a fifth distance between the partition wall 19 and the protrusion 20B along the direction parallel to the surface of the substrate 12. The first to fifth distances are non-zero physical distances.

In addition, according to an embodiment of the disclosure, the substrate 12 and the cover 14 of the optical sensor 10 can be joined adhesively, by adhesive layer 29. Similarly, the light emitter 16, the measurement photodetector 17, and the reference photodetector 18 can also be fixed on the substrate 12 adhesively. According to an embodiment of the disclosure, the adhesive layer can be formed of various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

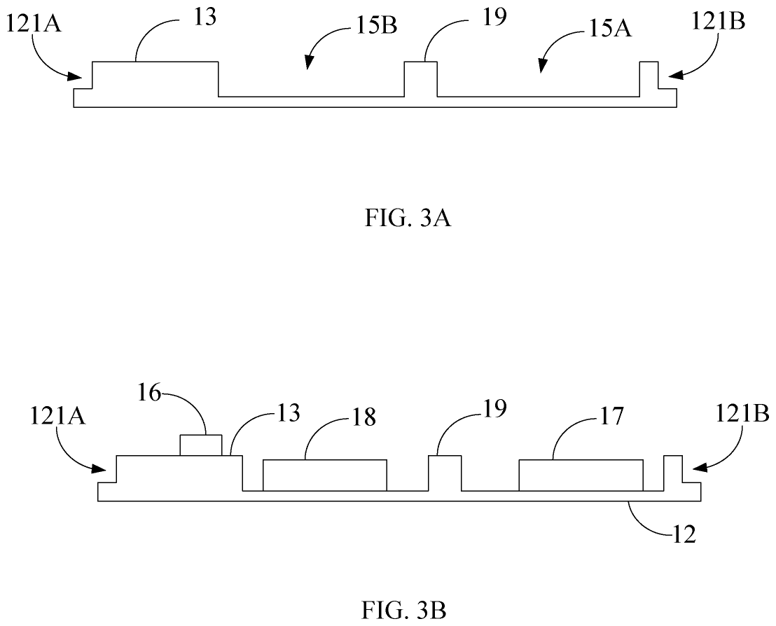

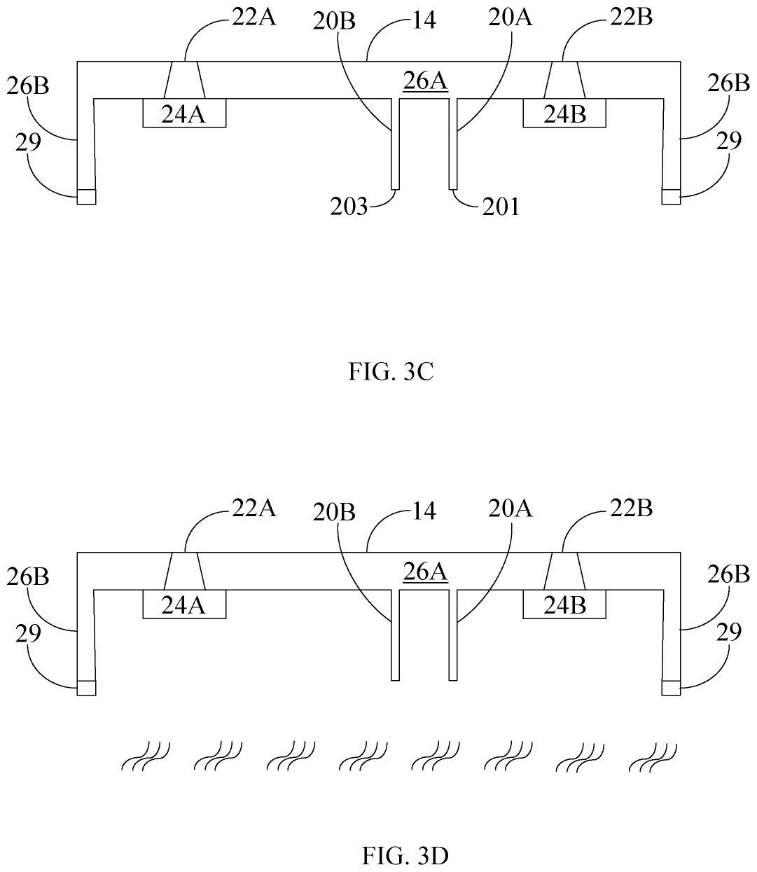

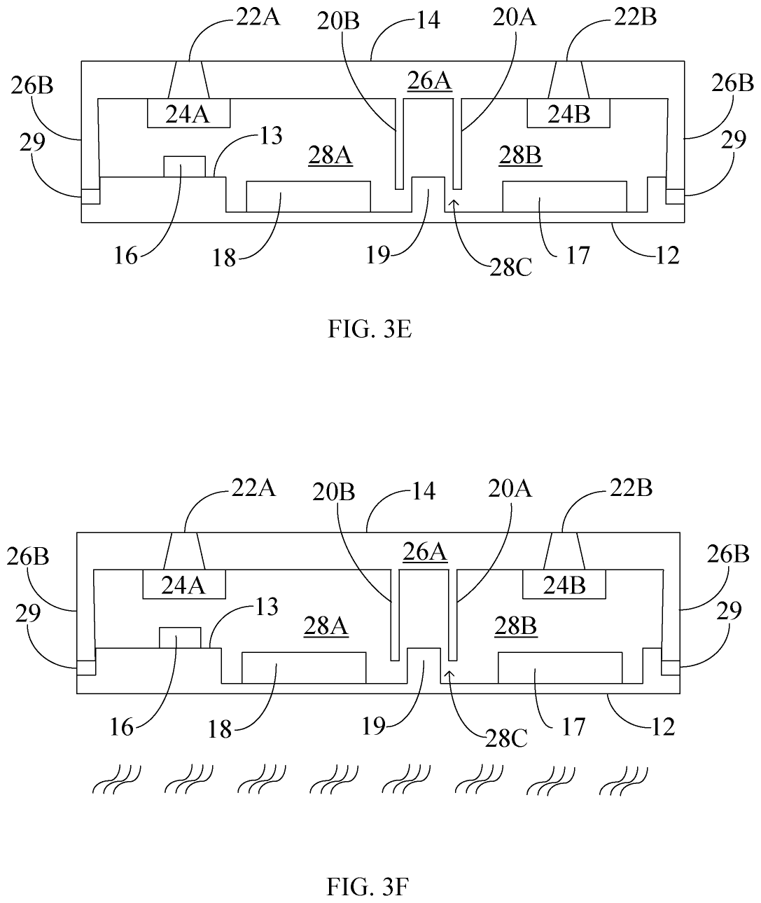

FIGS. 3A-3F illustrate other embodiments for implementation of the method of the disclosure. First, referring to FIG. 3A, a substrate 12 is provided. The substrate 12 has a surface 13, a first groove 15A, and a second groove 15B. There is a partition wall 19 between the first groove 15A and the second groove 15B. According to an embodiment of the disclosure, the partition wall 19 is a part of the substrate 12, and the top of the partition wall 19 is coplanar with the surface 13 of the substrate 12. In addition, there are accommodating grooves 121A and 121B on both sides of the substrate 12 for accommodating the cover 14.

The substrate 12 can be made of different materials, such as plastic materials, epoxy materials, composite materials, FR-4 materials, or ceramic materials. The substrate 12 has a connective structure which has bonding pads to couple with related electronic components. The related electronic components may include circuit components and control circuits necessary for implementing the function of transmitting or receiving light signals. The related electronic components are well known to those skilled in the art, and will not be repeated here.

Next, referring to FIG. 3B, the light emitter 16, the measurement photodetector 17, and the reference photodetector 18 can be disposed on the substrate 12. According to an embodiment of the disclosure, components can be attached to the substrate 12 through an adhesive layer, and electrical connections made by wire bonding (Wire Bonding), Tape Automated Bonding (TAB), Flip Chip (FC), etc.

In an embodiment of the disclosure, the light emitter 16 can be one or multiple vertical cavity surface emitting laser diodes (hereinafter referred to as VCSELs). The VCSELs form an array to emit light as signals. In other embodiments, the light emitter 16 can be surface-emitting laser diodes, light emitting diodes, edge emitting laser diodes (EELD), or distributed feedback lasers (DFB). In an embodiment of the disclosure, the light emitter 16 is used to emit light beams in the infrared waveband. In other embodiments, the light emitter 16 can also emit light in other wavebands such as visible light and ultraviolet light. The types of measurement photodetector 17 and reference photodetector 18 may include PN-type photodiodes, PIN-type photodiodes, and avalanche-type photodiodes.

Next, referring to FIG. 3C, a first optical filter 24A and a second optical filter 24B are provided on the cover 14. According to an embodiment, the material of the cover 14 may be an opaque plastic polymer material. The cover 14 comprises a top cover 26A and side walls 26B extending from the periphery of the top cover 26A toward the substrate 12. The cover 14 further comprises protrusions 20A and 20B, a first light transmitting portion 22A, and a second light transmitting portion 22B. The protrusions 20A and 20B are located on the surface of the top cover 26A facing the substrate 12 and extend toward the substrate 12. The protrusion 20A comprises a bottom 201, and the protrusion 20B comprises a bottom 203. According to an embodiment, the protrusions 20A and 20B may be independent elements or can be integrally formed with the top cover 26A. The first light filter 24A and the second light filter 24B are respectively fixed in the first light transmitting portion 22A and the second light transmitting portion 22B by adhesive.

The cover 14 can be joined to the substrate 12 in the accommodating grooves 121A and 121B through the adhesive layer 29. According to an embodiment of the disclosure, the adhesive layer 29 can be formed from various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

Next, referring to FIG. 3D, the cover 14 with the first light filter 24A and the second light filter 24B are baked or cured to solidify the adhesive layer between the light filters and the cover 14. According to the embodiment of the disclosure, the baking temperature can be controlled to be between 100° C. and 170° C. according to the materials of the first light filter 24A, the second light filter 24B, the cover 14, and the adhesive layer.

Next, referring to FIG. 3E, the cover 14 is connected to the substrate 12 and forms an internal space with the substrate 12. The internal space is divided by the protrusion 20A into a first chamber 28A and a second chamber 28B that communicate with each other. As shown in FIG. 3E, there is a communication chamber 28C between the first chamber 28A and the second chamber 28B, and between the bottom of the protrusion 20A and the substrate 12. After the cover 14 and the substrate 12 are combined, the partition wall 19 is located between the protrusions 20A and 20B. Since the top of the partition wall 19 is coplanar with the surface 13 of the substrate 12, the bottom of the protrusion 20A facing the substrate 12 is below the top of the partition wall 19, and the bottom of the protrusion 20B facing the substrate 12 is below the top of the partition wall 19.

As shown in FIG. 3E, there is a first distance between the bottom of the protrusion 20A and the first groove 15A, a second distance between the bottom of the protrusion 20B and the second groove 15B, a third distance between the top of the partition wall 19 and the top cover 26A, a fourth distance between the partition wall 19 and the protrusion 20A along the direction parallel to the surface of the substrate 12, and a fifth distance between the partition wall 19 and the protrusion 20B along the direction parallel to the surface of the substrate 12. The first to fifth distances are non-zero physical distances.

Next, referring to FIG. 3F, the combined cover 14 and the substrate 12 are baked or cured to solidify the adhesive layer between the cover 14 and the substrate 12. According to the embodiment of the disclosure, the baking temperature can be controlled to be between 100° C. and 170° C. according to the materials of the substrate 12, the cover 14, and the adhesive layer.

According to an embodiment of the disclosure, referring to FIG. 1, when the optical sensor performs distance measurement, the light emitter 16 located in the first chamber 28A emits a light beam according to the control signal issued by the control circuit (not shown in the figures). The reference photodetector 18 in the first chamber 28A detects the emitted light beam and generates a reference signal, this being at first time t1. The emitted light beam emitted by the light emitter 16 is emitted to the outside of the optical sensor through the first light filter 24A of the first light transmitting portion 22A. After being reflected by a target (not shown in the figures), the reflected light beam is transmitted into the second chamber 28B through the second light filter 24B of the second light-transmitting portion 22B. At this time, the measuring photodetector 17 in the second chamber 28B detects the reflected light beam and generates a measurement signal at second time t2. Next, the reference signal and measurement signal are transmitted to the control circuit. Since the reference signal and the measurement signal are respectively generated at the first time t1 and the second time t2, the control circuit can obtain the precise flight time of the measurable light beam (t2−t1) according to the reference signal and the measurement signal. The distance d between the optical sensor and the target to be measured can be obtained by calculating 50% of the product of the flight time (t2−t1) and the speed of light C, thus (d=C*(t2−t1)/2).

The distance measurement system using the optical sensors according to the embodiments of the disclosure can be applied to a variety of devices, such as smart phones, portable computers, smart watches, tablet computers, game devices, televisions, personal computers, internal communication systems, home automation systems, automotive security systems, 3D imaging systems, gesture control systems, touch sensors, fingerprint sensors, diagnostic systems, interactive displays, 3D sensing systems, household appliances, robot vacuum cleaners, display devices, iris recognition systems, etc.

According to the embodiments of the disclosure, since the measurement photodetector 17 and the reference photodetector 18 are respectively disposed in the first groove 15A and the second groove 15B, the size of the optical sensor is reduced. The partition wall 19 between the first groove 15A and the second groove 15B extends up between the protrusions 20A and 20B, which prevents the emitted beam entering through the communication area 28C. In addition, the emitted light beam is prevented from entering the second chamber 28B through the communication area 28C by the partition wall 19, which extends up between the protrusions 20A and 20B. There is no physical contact between the partition wall 19 and the protrusions 20A and 20B, which eliminates the manufacturing process of connecting the partition wall 19 with the protrusions 20A and 20B. This not only simplifies the manufacturing process, but also saves the cost of the adhesive layer. Furthermore, glue overflow or the risk of glue overflow when the adhesive layer is squeezed between the partition wall 19 and the protrusions 20A and 20B is avoided, and yield and product output are improved.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical sensor, comprising:
a substrate comprising a surface and a first groove;
a cover connected with the substrate and forming an internal space with the substrate, wherein the cover comprises a first protrusion, a first light transmitting portion, and a second light transmitting portion, the first protrusion extends toward the substrate and has a first bottom, divides the internal space into a first chamber and a second chamber connected to the first chamber, and the first bottom is located between the surface of the substrate and a bottom of the first groove;
a light emitter disposed on the surface of the substrate in the first chamber; and
a measurement photodetector disposed on the first groove in the second chamber.

2. The optical sensor of claim 1, wherein the first light transmitting portion is correspondingly positioned relative to the light emitter, and the second light transmitting portion is correspondingly positioned relative to the measurement photodetector.

3. The optical sensor of claim 1, wherein a distance is defined between the first bottom and the bottom of the first groove according to a preset value.

4. The optical sensor of claim 1, wherein the cover comprises a top cover and side walls extending from a periphery of the top cover toward the substrate, the side walls are connected to the substrate, and the first protrusion extends toward the substrate from the top cover.

5. The optical sensor of claim 1, wherein the substrate comprises accommodating grooves configured for accommodating the side walls.

6. The optical sensor of claim 4, wherein the substrate comprises a second groove in the first chamber, and a partition wall between the first groove and the second groove.

7. The optical sensor of claim 6, further comprising a reference photodetector disposed on the second groove.

8. The optical sensor of claim 6, wherein the cover further comprises a second protrusion, the second protrusion extends toward the substrate from the top cover and has a second bottom, the second bottom is located between the surface of the substrate and a bottom of the second groove, and the partition wall is located between the first protrusion and the second protrusion.

9. The optical sensor of claim 8, wherein there is no physical contact between the partition wall and the first protrusion and between the partition wall and the second protrusion.

10. The optical sensor of claim 1, wherein the light emitter emits a detection light beam according to a control signal, the first light transmitting portion is positioned to transmit the detection light beam towards a target to be measured, then a reflected light beam is reflected by the target to be measured, and the second light transmitting portion is positioned to transmit the reflected light beam to the measurement photodetector.

11. The optical sensor of claim 10, further comprising a control circuit configured for providing the control signal, wherein the reference photodetector generates a reference signal according to the detection light beam, the measurement photodetector generates a measurement signal according to the detection light beam, and the control circuit obtains a flight time according to the reference signal and the measurement signal.

12. The optical sensor of claim 1, further comprising a first light filter and a second light filter respectively disposed on the first light transmitting portion and the second light transmitting portion.

13. A method of manufacturing an optical sensor, comprising:
providing a substrate comprising a surface and a first groove;
providing a cover comprising a first protrusion, a first light transmitting portion, and a second light transmitting portion;
connecting the substrate with the cover and forming an internal space by the substrate and the cover, wherein the first protrusion extends toward the substrate and has a first bottom, divides the internal space into a first chamber and a second chamber connected to the first chamber, and the first bottom is located between the surface of the substrate and a bottom of the first groove;
disposing a light emitter on the surface of the substrate in the first chamber; and
disposing a measurement photodetector on the first groove in the second chamber.

14. The method of claim 13, wherein the first light transmitting portion is correspondingly positioned relative to the light emitter, and the second light transmitting portion is correspondingly positioned relative to the measurement photodetector.

15. The method of claim 13, further comprising arranging a distance between the first bottom and the bottom of the first groove according to a preset value.

16. The method of claim 13, wherein the cover comprises a top cover and side walls extending from a periphery of the top cover toward the substrate, the side walls are connected to the substrate, the first protrusion extends toward the substrate from the top cover; and the substrate comprises accommodating grooves configured for accommodating the side walls.

17. The method of claim 16, wherein the substrate comprises a second groove in the first chamber, and a partition wall between the first groove and the second groove.

18. The method of claim 17, further comprising disposing a reference photodetector on the second groove in the first chamber.

19. The method of claim 17, wherein the cover further comprises a second protrusion, the second protrusion extends toward the substrate from the top cover and has a second bottom, the second bottom is located between the surface and a bottom of the second groove, and the partition wall is located between the first protrusion and the second protrusion.

20. The method of claim 13, further comprising providing a first light filter and a second light filter respectively on the first light transmitting portion and the second light transmitting portion.
